(19) United States
(12) Patent Application Publication
(10) Pub. No.: US 2026/0004351 A1
(43) Pub. Date: Jan. 1, 2026

(54) DYNAMIC CRYTOCURRENCY INERTIA SYSTEM

(71) Applicant: VOLMEX LABS CORPORATION, Brooklyn, NY (US)

(72) Inventors: Nicholas Kennelly, Brooklyn, NY (US); Kadir Gokhan Babaoglu, Çigli Izmir (TR)

(73) Assignee: VOLMEX LABS CORPORATION, Brooklyn, NY (US)

(21) Appl. No.: 19/268,248

(22) Filed: Jul. 14, 2025

Related U.S. Application Data
(63) Continuation-in-part of application No. 19/140,316, filed on Jan. 1, 0001.
(60) Provisional application No. 63/375,671, filed on Sep. 14, 2022.
(60) Provisional application No. 63/671,541, filed on Jul. 15, 2024.

(51) Int. Cl. G06Q 40/04; H04L 67/02

(52) U.S. Cl. CPC G06Q 40/042; H04L 67/02

(57) ABSTRACT

Apparatus and associated methods relate to global implied volatility assessment in a dynamic inertia system. In an illustrative example, a global implied volatility assessment system (GIVAS) may include a market data standardization module configured to receive updates of option contracts of a cryptocurrency from multiple data tracking devices. For example, the option contracts value may be prone to outlying events causing discontinuity in a time-series of the value. The received update may, for example, be aggregated into a global order book (GOB) including instantaneous representations of the option contracts among the multiple data tracking devices. Based on the GOB, the GIVAS may generate a global raw volatility characterization (GRVC) of the option contracts. An infinite impulse response filter may be applied to the GRVC to generate a transient-dampened volatility characterization. Various embodiments may advantageously generate a transient-dampened volatility metric usable for analyzing the option contract value by external code.

### CROSS-REFERENCE TO RELATED APPLICATIONS

This application is a continuation-in-part of and claims the benefit of U.S. Non-Provisional application Ser. No. 19/140/316, titled “DYNAMIC CRYPTOCURRENCY INERTIA SYSTEM,” filed Nicolas Kennelly, et al., on Jun. 17, 2025.

This application also claims the benefit of International Application No. PCT/US23/73994, titled “DYNAMIC CRYPTOCURRENCY INERTIA SYSTEM,” filed Nicolas Kennelly, et al., on Sep. 12, 2023.

This application also claims the benefit of U.S. Provisional Application Ser. No. 63/375,671, titled “Dynamic Cryptocurrency Inertia System,” filed by Nicolas Kennelly, et al., on Sep. 14, 2022.

This application also claims the benefit of U.S. Provisional Application Ser. No. 63/671,541, titled “MARKET IMPLIED VOLATILITY INDEX,” filed by Nicolas Kennelly, et al., on Jul. 15, 2024.

This application incorporates the entire contents of the foregoing application(s) herein by reference.

### TECHNICAL FIELD

Various embodiments relate generally to large volume trade data processing.

### BACKGROUND

A cryptocurrency, crypto-currency, or crypto is a form of digital asset based on a network that is distributed across a large number of computers (e.g., a blockchain). This decentralized structure allows them to exist outside the control of governments and central authorities. Crypto assets may be traded privately from peer to peer, as well as publicly on exchange platforms (e.g., a crypto market). The crypto market has a total size of approximately 2.5% of the global stock market. Crypto markets may, for example, be more volatile than the traditional stock market.

### SUMMARY

Apparatus and associated methods relate to global implied volatility assessment in a dynamic inertia system. In an illustrative example, a global implied volatility assessment system (GIVAS) may include a market data standardization module configured to receive updates of option contracts of a cryptocurrency from multiple data tracking devices. For example, the option contracts value may be prone to outlying events causing discontinuity in a time-series of the value. The received update may, for example, be aggregated into a global order book (GOB) including instantaneous representations of the option contracts among the multiple data tracking devices. Based on the GOB, the GIVAS may generate a global raw volatility characterization (GRVC) of the option contracts. An infinite impulse response filter may be applied to the GRVC to generate a transient-dampened volatility characterization. Various embodiments may advantageously generate a transient-dampened volatility metric usable for analyzing the option contract value by external code.

Apparatus and associated methods relate to global implied volatility assessment in a dynamic inertia system. In an illustrative example, data from multiple asset exchanges may be received and standardized into a global order book (GOB). The GOB may, for example, include cryptocurrency futures orders across multiple currencies. A volatility metric generation module may be applied to the GOB to generate a global volatility metric (GVM). The GVM may, for example, be a cryptocurrency GVM. The GVM may, for example, be generated by filtering a raw implied volatility (IV) metric based on at least one dynamic smoothing parameter. The filter may, for example, include an infinite impulse response filter. One or more user interfaces (UIs) may be generated based on the GVM. Various embodiments may advantageously provide an easily readable global (e.g., multi-exchange, multi-jurisdiction, multi-currency) asset inertia system resistant to transient market manipulation for select assets, such as cryptocurrencies.

Various embodiments may achieve one or more advantages. For example, some embodiments may advantageously provide a data structure for volatility assessment of a crypto asset. Some embodiments, for example, may advantageously reflect expectations of market participants about a price range of the underlying asset over the life of the contract. For example, some embodiments may advantageously avoid technical predictability from past events based on a finite window of data. Some embodiments, for example, may advantageously eliminate finite window volatility artifacts. For example, some embodiments may generate a finer grid to advantageously stabilize a raw implied volatility. Some embodiments, for example, may advantageously capture fundamental trends in the market. For example, some embodiments may advantageously remove finite window discontinuity artifacts resulting from the outlying events based on the transient-dampened global order book. Some embodiments, for example, may advantageously generate a noise subdued implied volatility index.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary global implied volatility assessment system (GIVAS) employed in an illustrative use-case scenario.

FIG. 2 is a block diagram depicting an exemplary data flow of an exemplary GIVAS.

FIG. 3 is a block diagram depicting an exemplary GIVAS.

FIG. 4 is a flowchart illustrating an exemplary global implied volatility assessment generation method.

FIG. 5 is a flowchart illustrating an exemplary global order book generation method.

FIG. 6 is a flowchart illustrating an exemplary continuous global volatility metric method.

FIG. 7 depicts exemplary user interfaces displaying exemplary market data including an exemplary cryptocurrency global volatility metric for Ethereum and Bitcoin, respectively.

FIG. 8 depicts illustrative experimental data of raw IV values and corresponding filtered IV values (e.g., a cryptocurrency global volatility metric (CGVM)) for Bitcoin and Ethereum.

FIG. 9 shows exemplary steps in generating a market wide implied volatility index (MVIV).

FIG. 10 shows exemplary steps in generating a generalized MVIV.

Like reference symbols in the various drawings indicate like elements.

### DETAILED DESCRIPTION OF ILLUSTRATIVE EMBODIMENTS

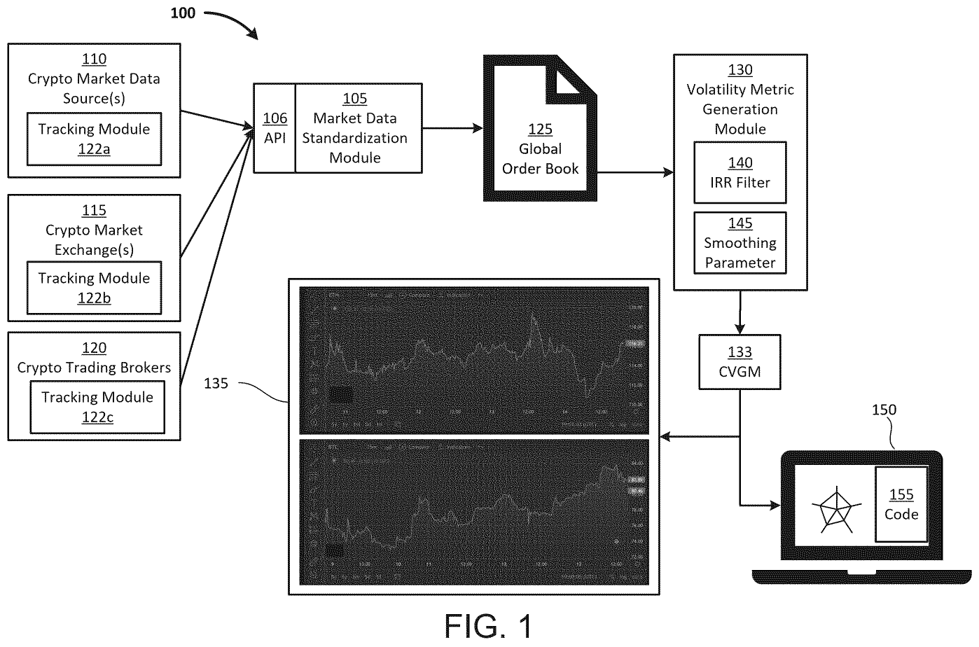

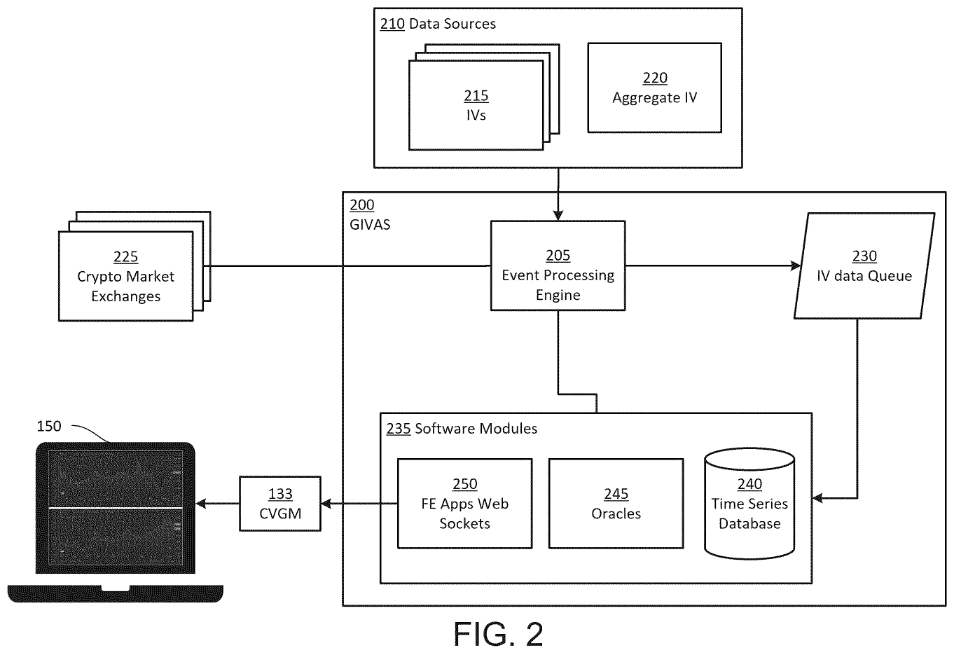

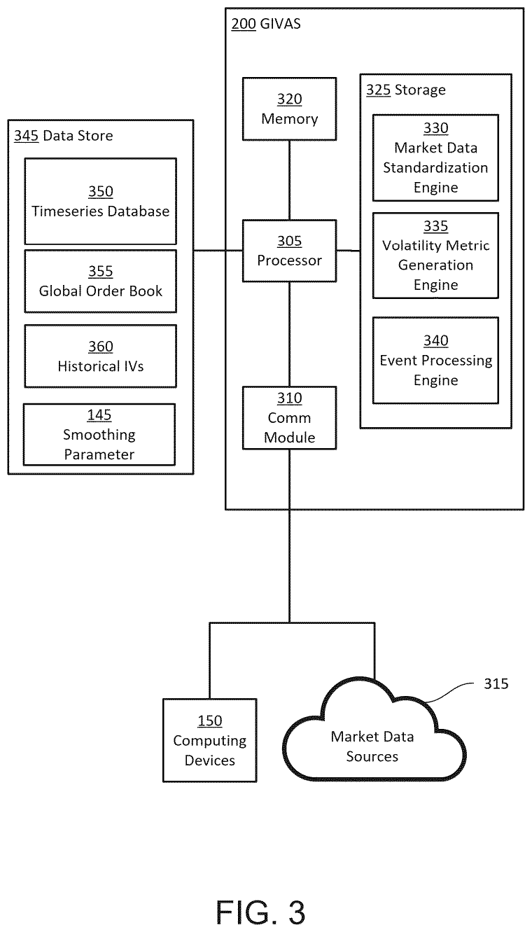

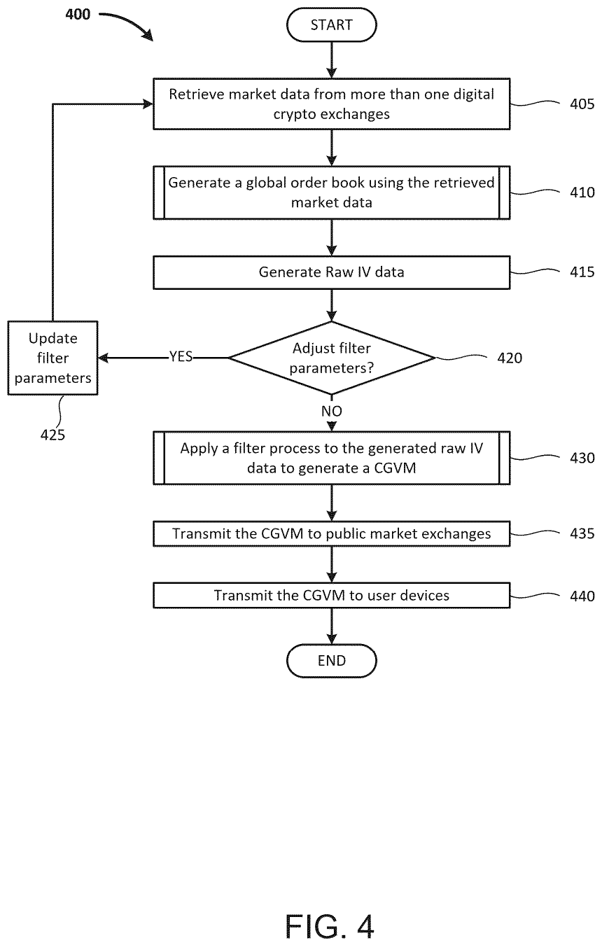

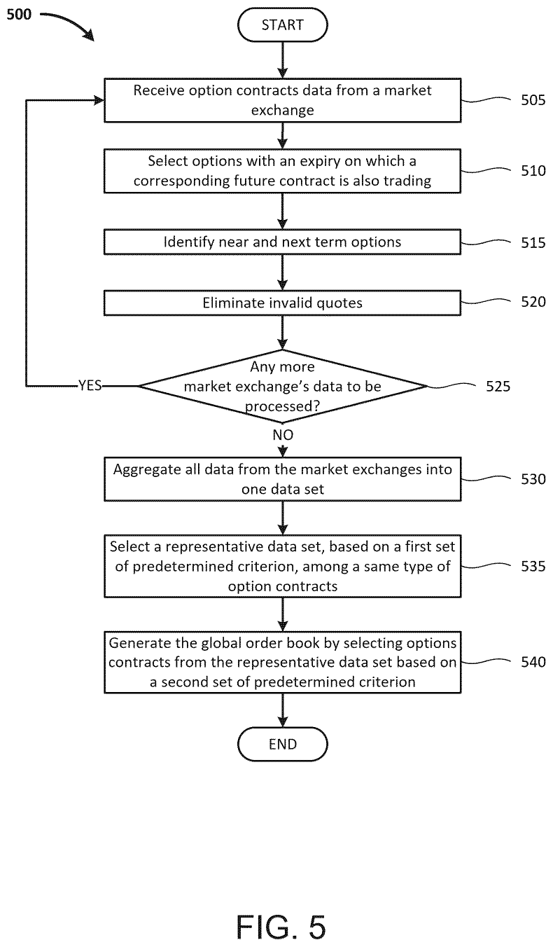

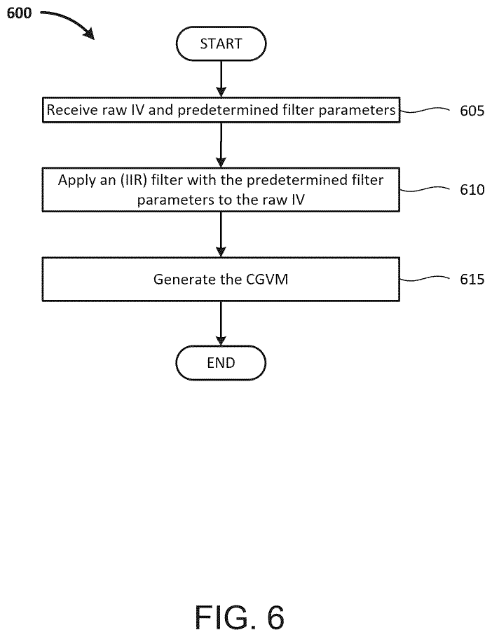

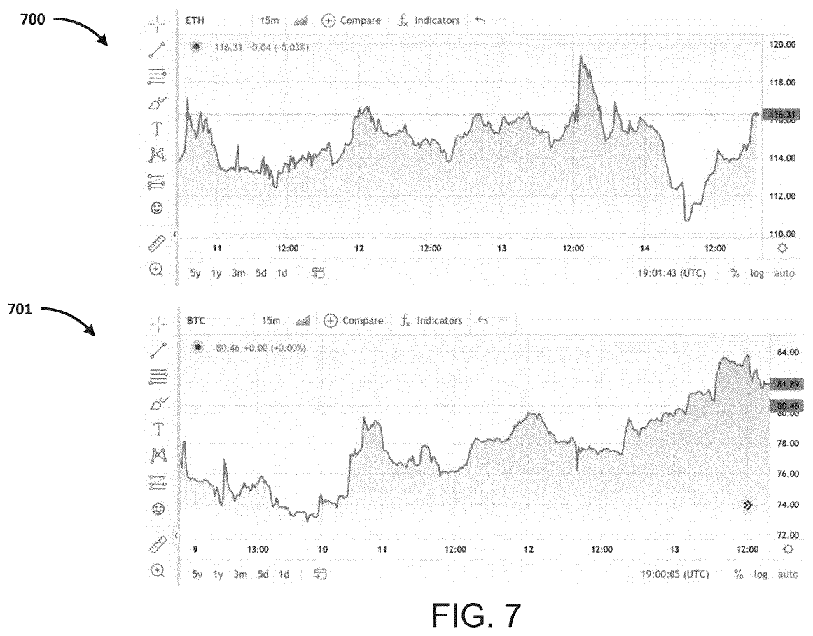

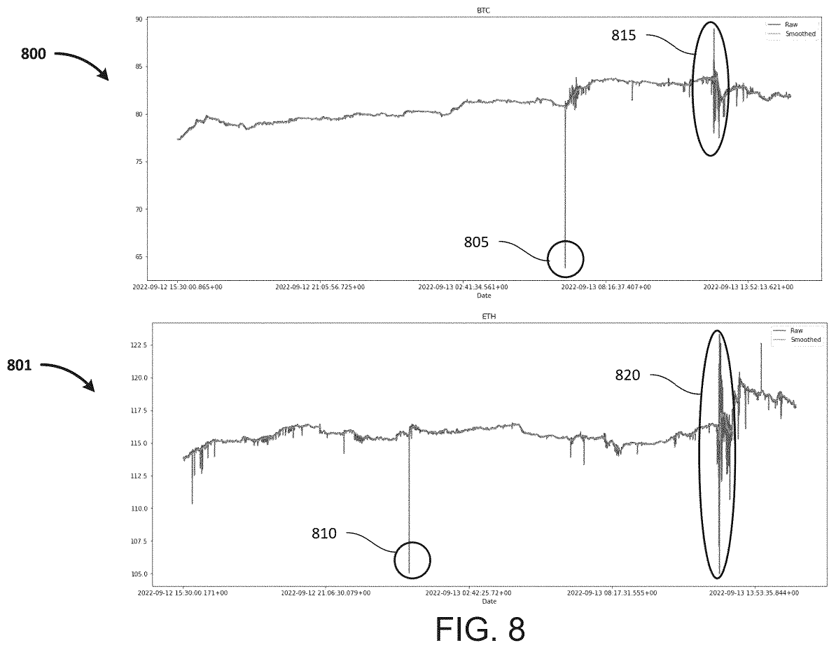

To aid understanding, this document is organized as follows. First, to help introduce discussion of various embodiments, a global implied volatility assessment system (GIVAS) is introduced with reference to FIGS. 1-2. Second, that introduction leads into a description with reference to FIG. 3 of some exemplary embodiments of an exemplary computer device embedding the GIVAS. Third, with reference to FIGS. 4, an exemplary global implied volatility assessment generation method is described in application to generate, for example, a cryptocurrency global volatility metric (CGVM). Fourth, with reference to FIGS. 5-6, this document describes exemplary apparatus and methods useful for generating a global order book and removing discontinuity artifacts. Sixth, this disclosure turns to a review exemplary output display from the GIVAS with reference to FIGS. 7-8. Finally, the document discusses further embodiments, exemplary applications and aspects relating to GIVAS.

FIG. 1 depicts an exemplary global implied volatility assessment system (GIVAS 100) employed in an illustrative use-case scenario. In this example, a market data standardization module (MDSM 105) receives market data from various external sources. For example, the MDSM 105 may include an application programming interface (API 106). For example, the API 106 may be configured to directly poll market data from the external sources. For example, the API 106 may include one or more keys for the MDSM to access the external sources.

In this example, the MDSM 105 receives market data from one or more crypto market data sources (CMDSs 110), crypto market exchanges (CMEs 115), and crypto trading brokers (CTBs 120). For example, the market data may be related to an underlying asset (e.g., a crypto asset) requested by the API 106. For example, the MDSM 105 may independently receive one or more of the market data from CMDSs 110, the CMEs 115, and/or the CTBs 120. For example, the market data may include option data of option contracts. For example, the CMDSs may include real-time financial market databases (e.g., YAHOO! FINANCE® of by Yahoo Inc. headquartered in Sunnyvale, California, TradingView® of TradingView, Inc. headquartered in London, United Kingdom, Refinitiv R® of Refinitiv US Organization LLC headquartered in New York City, New York). The CMEs 115, for example, may include options and derivatives trading platforms (e.g., Deribit, OKX®of Guangzhou Daguang Technology Co., Ltd. headquartered in Guangzhou, China, COINBASE® of Coinbase, Inc. headquartered in San Francisco, California, BINANCE® of Binance Holdings Limited headquartered in Cayman Islands, CEX.IO). The CTBs may, for example, include trading brokers (e.g., InteractiveBrokers® of Interactive Brokers LLC headquartered in Greenwich Connecticut).

In this example, the CMDSs 110 includes a tracking module 122a, the CMEs 115 includes a tracking module 122b, and the CTBs 120 includes a tracking module 122c. The tracking modules 122a-c may, for example, be a software module installed in the CMDSs 110, CMEs 115, and the CTBs 120, respectively. For example, the tracking modules 122a-c may be a computing server. For example, the tracking modules 122a-c may be configured to determine various characteristics (e.g., a present value, future values, time values, volatility index, fundamentals) of an underlying asset. For example, the tracking modules 122a-c may be configured to collect market data of one or more underlying assets. In various examples, the API 106 may be configured to communicate with the tracking modules 122a-c to receive updates in the market data corresponding to one or more underlying asset. For example, the API 106 may (independently) receive temporal updates (e.g., at an interval of less than 1 second, at an interval of less than 5 seconds) of the market data from the tracking modules 122a-c.

In various implementations, the market data may include real-time and/or historical price information and corresponding timestamp of the information. For example, the market data may include a dataframe data object (e.g., in json, in xml, in yaml, in protobuf) that may store the real-time and/or historical price information and corresponding timestamp of the requested underlying asset. In some implementations, the market data may include one or more time-series of data. In some examples, external sources (CMDSs 110, CMEs 115, and CTBs) may update a current price information of crypto assets (e.g., bitcoin, Ethereum, DAI, USDT) in real-time.

In some implementations, the option data may also include option contracts of various underlying assets traded on the CMEs 115. For example, the market data may include bid/ask quotes and mark prices for each option contract. After receiving the market data, the MDSM 105 processes the received market data and generate a global order book (GOB 125). For example, the GOB may selectively include market data from the external sources (e.g., the CMDSs 110, the CMEs 115, and/or the CTBs 120).

In this example, a volatility metric generation module (VMGM 130) receives the GOB 125 to generate a cryptocurrency global volatility metric (CGVM 133) to be displayed on a user interface 135. For example, the GOB 125 may consolidate and standardize global options data across multiple exchanges in multiple currencies in real-time (e.g., with updates occurring in less than 1 second intervals). For example, for presenting an internal state of multiple exchange systems, and/or for further transformation by computing devices (e.g., by performing further calculations).

In some examples, the GOB 125 may include a new form of data. For example, the GOB 125 may include an improved function of data structures. For example, the new form of data may include a global order book including an instantaneous representation of the unstable time-series object (e.g., the market data from the CMDSs 110, the CMEs 115, and the CTBs 120). For example, the GOB 125 may enable a computer system to do things to automatically generate a global volatility metric characterizing a volatility of a temporally updated unstable time-series that it could not do before (with removed discontinuity artifacts).

For example, the CGVM 133 may include volatility assessment of a crypto asset. Further discussion on the user interface 135 is described with reference to FIG. 7. In various implementations, the CGVM 133 may be generated periodically and/or continuously. For example, the CGVM 133 may be generated at an interval of less than or equal to 1.5 second.

In some embodiments, the CGVM 133 may include an implied volatility (IV). For example, the IV may be a fear gauge of investors (e.g., of participants in the CMEs 115). IV may, for example, be used to refer to volatility that is extracted from (and implied by) options by matching the price of these contracts. IV may be a single number that combines all the information across available strikes for a given expiry.

As shown, a computing device 150 (e.g., a computer, a mobile device using a mobile application) may receive the CGVM 133. For example, the computing device 150 may be authenticated by the VMGM 130 to access the CGVM 133. For example, the computing device 150 may be authenticated using a passkey. For example, the VMGM 130 may require the computing device 150 to pass a two-step authentication (2FA). In some examples, a user may program (e.g., using customizable external code 155, using a graphical user interface) the computing device 150 to measure (e.g., infer, gauge, compute, or otherwise determine) an overall expensiveness of option contracts of the underlying asset behind the user interface 135. For example, the user may use the customizable external code 155 to use the CGVM 133 to generate data analysis results. For example, the user may use the data analysis results to make decision regarding the underlying asset associated with the CGVM 133. Accordingly, the VMGM 130, for example, may advantageously provide a data structure (e.g., the CGVM 133) for volatility assessment of a crypto asset.

In some examples, pricing of options depends not only on the price level of the underlying asset but also on its volatility. For example, the volatility of the underlying asset may be a latent variable. This latent variable (e.g., the IV) may, for example, be unavailable directly at the market data supplied from the CMDSs 110, the CMEs 115, and/or the CTBs 120. For example, a user may traditionally resort to infer (e.g., using insights, feelings) the unavailable and/or unquantified latent variables from the market prices of option contracts. In some embodiments, the MDSM 105 and the VMGM 130 may generate the CGVM 133 to indicate an expected volatility as a function of a user-selected parameter (e.g., from a present time to a user-selected expiration). For example, the user-selected parameter may be selectively determined using the user interface 135 and/or using the customizable external code 155 programmed in the computing device 150. Accordingly, for example, the CGVM 133 may advantageously reflect expectations of market participants (e.g., the option market participants, the crypto market participants) about a price range of the underlying asset over the life of the contract. Various embodiments may include forward-looking (e.g., predictive) quantitative characteristics (e.g., IV) of the underlying asset.

In this example, the VMGM 130 includes an infinite impulse response (IIR filter 140) and a smoothing parameter 145. For example, the VMGM 130 may use the IIR filter 140 to include available historical data to generate the CGVM 133. For example, the CGVM 133 may be transient dampened by the IIR filter 140. In some examples, the VMGM 130 may use the IIR filter 140 to advantageously avoid technical predictability from past events based on a finite window of data. In some implementations, the smoothing parameter 145 may be selected by a user using the user interface 135. The IIR filter 140 may, for example, be modified by the smoothing parameter 145. In some examples, the IIR filter 140 may be an exponentially weighted moving average (EWMA). In some implementations, the smoothing parameter may be associated with a half-life of data within the IIR filter window.

In some implementations, the GIVAS 100 may be configured to measure a volatility index for an underlying asset that are prone to outlying events. In various examples, due to a nature of the crypto market, sudden changes and/or outlying market events (e.g., discrete “jump” or “free fall” in prices) may occur more frequently. For example, the outlying event may cause a sudden price drop in a price of the cryptocurrency option contract. Using the IIR filter 140 and the smoothing parameter, for example, the VMGM 130 may advantageously eliminate finite window volatility artifacts. For example, the GIVAS 100 may include the smoothing parameter 145 such that, after a predetermined time (e.g., 2 minutes), effects on the market data and quantitative evaluation of the underlying asset from the sudden change in the market data may be (visually) disappeared (e.g., at the user interface 135).

In various embodiments, the GIVAS 100 may overcome technical problems in network of exchanges (e.g., independent exchanges, the CMEs 115). For example, the GIVAS 100 may overcome a problem specifically arising the realm of numerical analysis of unstable objects such as cryptocurrency (e.g., by generating a global volatility metric of the unstable time-series object using the transient-dampened volatility characterization).

As an illustrative example, the market data may include a timestamp of a time when the market data are collected. In some implementations, the MDSM 105 may retrieve forward prices associated with each option contract. For example, these prices may be used as the mark prices of the option contracts. For example, the most recent price of an underlying of all available prices may be used as a global price for the asset to generate a yield curve for later calculation.

In some implementations, the MDSM 105 may process the received market data and generate the GOB 125. For example, the MDSM 105 may generate an interest rate using the global price based on the formula below.

$$F = S \times {e}^{r \times t}$$

where F is the forward price, S is the underlying price level, t is year-to-maturity (YTM) and r is the interest rate. Thus, the implied interest rate is

$${r}_{imp} = \frac{ln F - ln S}{t}$$

For example, when the implied interest rates are calculated for the received future contracts, the MDSM 105 may generate an average interest rate for each expiry term of the future contracts. In some implementations, the interest rate may be used to generate the yield curve for each of the underlying asset.

In some implementations, when forward prices are not available, the MDSM 105 may generate forward prices by standardizing the option data. For example, the MDSM 105 may aggregate bid/ask quotes of options contracts of an asset. For example, the MDSM 105 may pick the maximum bid and minimum ask for each maturity of the option contracts. A mid-price, for example, may be generated as a function of an average of bid and ask prices as the forward price. Then, the interest rates for each maturity and the yield curve may be determined using above equations.

In some implementations, the MDSM 105 may filter invalid quotes from the GOB 125. For example, quotes having negative bid/ask spread, out of bid/ask range mark price, and negative mark price may be filtered.

In some implementations, the MDSM 105 may select a representative contracts of bid and ask quote for each option contract with same type (e.g., call or put), strike, and expiry. For example, the MDSM 105 may select based on a number of quotes (e.g., select quote with a maximum number of bids and a minimum of asks available). For example, the MDSM 105 may select the option contract based on mark prices (e.g., mark price of the option with smallest bid/ask spread is selected). In some implementations, the MDSM 105 may filter in consistent quote to minimize noise.

In various implementations, the MDSM 105 may iterate through each options contract. For example, as the MDSM 105 is iterating through strike prices for a given expiry, call option prices may decrease as the strike price increases. For example, the selected bid/ask price may be replaced with the bid/ask price at lower strike if the current strike price is higher than the price at the immediate lower strike (e.g., a previous price). Similarly, for example, put option prices may decrease as the strike price decreases. In various examples, the MDSM 105 may generate the GOB 125 after processing the market for the VMGM 130 to determine the CGVM 133.

In various embodiments, the CGVM 133 may include IV for near term and next term options. For example, the near term options may be options expiring within a predetermined index maturity date (e.g., 30 days). For example, the next term options may be options expiring out of the predetermined index maturity date. For example, the VMGM 130 may generate the implied variance based on

$${σ}_{i , t}^{2} = \frac{1}{{T}_{i}} ( 2 {\sum }_{j} {w}_{i , j} V ( {K}_{j} ) - {( \frac{{F}_{i}}{{K}_{i , ATM}} - 1 )}^{2} )$$

where

$${w}_{i , j} = {e}^{{r}_{i} {t}_{i}} \frac{Δ {K}_{j}}{{K}_{j}} ,$$

I∈{NEAR, NEXT}, Fᵢ is the implied forward price, K_{i,ATM} is the at the money (ATM) strike level, V (K) is the price of out of money (OTM) option with strike K, and Tᵢ is years to expiry.

In some implementations, the VMGM 130 may determine a strike range to be from Kmin to Kmax by log-linearly extrapolating the strike prices. For example, the VMGM 130 may use slopes between a top point (e.g., with an ATM strike option price) and last points available on each side (e.g., lowest and highest valid strikes and option prices). In some implementations, the VMGM 130 may extend (e.g., expand) a number of strikes and option prices using a log-linear piece-wise interpolation (e.g., and/or extrapolation) in order for computing the IV. For example, using interpolation and/or extrapolation, the VMGM 130 may generate a finer grid to advantageously stabilize the raw IV, for example, when the market of the underlying asset becomes less liquid.

Once

$${σ}_{NEAR , t}^{2} and {σ}_{NEXT , t}^{2}$$

following the formula above, for example, implied variance at the index maturity may be interpolated using the weighting scheme below:

$${w}_{NEAR , t} = \frac{{T}_{NEXT} - {T}_{INDEX} / {T}_{INDEX}}{{T}_{NEXT} - {T}_{NEAR} / {T}_{NEAR}}$$

$${w}_{NEXT , t} = \frac{{T}_{INDEX} - {T}_{NEAR} / {T}_{INDEX}}{{T}_{NEXT} - {T}_{NEAR} / {T}_{NEXT}}$$

where T_{INDEX} has been set as 30/365 (where 30/365 is the annualization of 30 days).

Then, a raw value of implied variance at the index maturity may be calculated as

$${σ}_{RAW , t}^{2} = {w}_{NEAR , t} {σ}_{NEAR , t}^{2} + {w}_{NEXT , t} {σ}_{NEXT , t}^{2}$$

which is calculated continuously at a frequency that the MDSM 105 may acquire new data.

After the raw value of implied variance is determined, the VMGM 130 may apply the IIR filter 140 to generate a smoothed implied variance (the CGVM 133). For example, the VMGM 130 may apply a EWMA process as below:

$${σ}_{SMOOTH , t}^{2} = λ {σ}_{SMOOTH , t - 1}^{2} + λ {σ}_{RAW , t}^{2}$$

where

$${σ}_{SMOOTH , t - 1}^{2}$$

is the previous value smoothed implied variance and its weight is the smoothing parameter 145. In some implementations, the degree of smoothing may be adjusted by the smoothing parameter 145.

In various implementations, the GIVAS 100 may calculate the implied volatility of crypto assets at a given expiry by globally standardizing option and futures data across multiple exchanges to create the GOB 125. The GIVAS 100 may also generate a noise reduced final index by smoothing using the IIR filter 140 that takes every observation into account. In various examples, the transient-dampened final index may advantageously capture the fundamental trends in the market. For example, the smooth final index may advantageously suppress transient market manipulation and/or other ‘technical’ trends (e.g., temporary trends) not related to the financial fundamentals.

In various implementations, a method for generating a volatility index (e.g., the CGVM 133) of an asset valuation may include generating a global order book (e.g., the GOB 125) by consolidating multiple time-series of instantaneous evaluation data of an unstable object class (e.g., a cryptocurrency, a cryptocurrency options contract) from a plurality of independent exchange platforms (e.g., from the CMDSs 110, the CMEs 115, and the CTBs 120). For example, at least some of instantaneous evaluation data may include non-continuous data triggered by outlying events (e.g., discrete jump or free fall in prices for a cryptocurrency due to market event). For example, the method may also include generating a transient dampened latent metric (e.g., the CGVM 133) by applying an infinite impulse response filter (e.g., the IIR filter 140 and the smoothing parameter 145) to remove technical predictability. For example, finite window discontinuity artifacts resulting from the outlying events may advantageously be removed. generate a global volatility metric based on the transient-dampened global order book. Various embodiments may advantageously improve results in a technical field of generating a global volatility metric characterizing a volatility of a temporally updated unstable time-series with removed discontinuity artifacts.

FIG. 2 is a block diagram depicting an exemplary data flow of an exemplary GIVAS 200. For example, the GIVAS 200 may generate a volatility index of various crypto assets to be displayed to a user. As shown, the GIVAS 200 includes an event processing engine (EPE 205).

For example, the EPE 205 may generate a triggering event. For example, based on the triggering event, the EPE 205 may transmit CGVM data (e.g., the CGVM 133) to external entities for further processing. For example, the external entities may include external code configured to process the CGVM 133.

As shown, the EPE 205 is connected to data sources 210. For example, the EPE 205 may be connected to a predetermined number (1, 2, 3, . . . N) of data sources 210. For example, each of the data sources 210 may generate a time-series data stream to the EPE 205. For example, the EPE 205 may aggregate the 1^{st}, 2^{nd}, . . . , Nth time series representation of market data form the data sources 210. As shown, the data sources 210 include IVs 215 from various sources (e.g., various crypto option exchanges), and an aggregated IV 220. In some implementations, the IVs 215 and the aggregated IV 220 may be unavailable from a raw data stream received from the data sources 210. For example, the IVs 215 and the aggregated IV may be continuously generated by the MDSM 105 and the VMGM 130 as described with reference to FIG. 1. In some implementations, the EPE 205 may poll updated data from the data sources 210 periodically (e.g., every second, every minute).

The EPE 205 is also connected to crypto market exchanges 225. For example, the EPE 205 and the crypto market exchanges 225 may be connected via a real-time communication channel established in Hypertext Transfer Protocol Secure (HTTPS) protocol. In various implementations, the crypto market exchanges 225 may request updated IV data from the EPE 205. In some examples, the EPE 205 may also push the updated IVs to the crypto market exchanges 225 in real-time.

In some implementations, the EPE 205 may pull data from the crypto market exchanges 225. For example, the EPE 205 may determine whether an outlying event occurred (in real-time) based on the market data from the crypto market exchanges 225. For example, the EPE 205 may generate a request to a user to adjust the customizable external code 155 based on a type and a size of the determined outlying event.

As an illustrative example without limitation, the crypto market exchanges 225 may include external codes (e.g., the customizable external code 155) that are programmed to listen to data (e.g., the CGVM 133) transmitted from the EPE 205. For example, in response to the data received from the EPE 205, the crypto market exchanges 225 may update information (e.g., prices, value), perform further analysis on the underlying asset (e.g., generating future predictions, determining a decisions based on the received information), update information presented to other end-users, or a combination thereof.

As shown, the EPE 205 also transmit the IV data to an IV data queue 230. In this example, the IV data queue 230 may be used by software modules 235. For example, the software modules 235 may be used by the customizable external code 155 of the computing device 150. For example, the customizable external code 155 may be programmed to invoke functions of the software modules 235.

In this example, the software modules 235 include a time series database 240, oracles 245, and front-end Apps Web Sockets (FEAWS 250). For example, the time series database 240 may request the IV data queue to update historical data stored in the time series database 240.

In some implementations, the customizable external code 155 may include applications configured to be executed on a blockchain. For example, the customizable external code 155 may be performed on an Ethereum virtual machine (EVM). The oracles 245, for example, may interface between applications on a blockchain (on-chain) and off the blockchain. For example, the oracles 245 may be operably connected to on-chain applications that uses the IV data queue. For example, the on-chain application may use the IV data queue to perform real-time analysis. For example, the on-chain application may use the IV data queue to perform automatic high frequency trading.

The FEAWS 250 may, for example, generate front end interface for users to use the IV data. In this example, the FEAWS 250 transmit a display to a computing device 150 (e.g., a laptop, a mobile device, a personal computer). In some examples, the computing device 150 (FIG. 1) may also use the FEAWS 250 to interact with functions and software modules in the GIVAS 200.

In some embodiments, the GIVAS 200 may generate a noise reduced volatility index (the CGVM 133) for an independently exchanged (e.g., in the N data sources) Cryptocurrency that includes discontinuity in the data. For example, the GIVAS 200 may consolidate and standardize global options data across multiple exchanges in multiple currencies in real-time (e.g., with updates occur in less than 1 second intervals). In some implementations, the GIVAS 200 may, for example, process and present (e.g., at the computing device 150) an internal state of an underlying asset (e.g., a cryptocurrency, option contracts of the cryptocurrency) from multiple exchange systems (e.g., the data sources 210). For example, the internal state may be transmitted to the computing device 150 for further transformation (e.g., by performing further calculations).

FIG. 3 is a block diagram depicting an exemplary GIVAS 200. The GIVAS 200 includes a processor 305. The processor 305 may, for example, include one or more processing units. The processor 305 is operably coupled to a communication module 310. The communication module 310 may, for example, include wired communication. The communication module 310 may, for example, include wireless communication. In the depicted example, the communication module 310 is operably coupled to the computing device 150 and market data sources 315. For example, the market data sources 315 may be accessed via the Internet. In some implementations, the market data sources 315 may include data sources on a blockchain.

The processor 305 is operably coupled to a memory module 320. The memory module 320 may, for example, include one or more memory modules (e.g., random-access memory (RAM)). The processor 305 includes a storage module 325. The storage module 325 may, for example, include one or more storage modules (e.g., non-volatile memory). In the depicted example, the storage module 325 includes a market data standardization engine (MDSE 330), a volatility metric generation engine (VMGE 335), and an event processing engine (EPE 340). The MDSE 330 may, for example, retrieve option data and market data form the market data sources 315. For example, the MDSE 330 may further process the retrieved data to generate the GOB 125. The VMGE 335 may, for example, generate a raw volatility index based on the GOB 125. For example, the VMGE 335 may advantageously apply an IIR filter (e.g., the IIR filter 140) to generate a noise subdued implied volatility index (e.g., the CGVM 133). The EPE 340, for example, may transmit the generated volatility index to internal and/or external entities for applications. For example, the EPE 340 may store the updated IVs to a database. Various implementations of the EPE 340 may be referred to the EPE 205 described with reference to FIG. 2.

The processor 305 is further operably coupled to the data store 345. The data store 345, as depicted, includes a time series database 350, a global order book 355, and historical IVs 360. The time series database 350 may include analyzed data series generated based on the IV generated by the VMGE 335 and other information (e.g., price of underlying asset, price of other assets). For example, the time series database 350 may be generated from market data received from the data sources 210. For example, the data sources 210 may include the CMDSs 110, the CMEs 115, and/or the CTBs 120. The global order book 355 may include historical GOB generated by the MDSE 330. For example, the global order book 355 may include the GOB 125. The historical IVs 360 may include IVs previously generated by the GIVAS 200. For example, the historical IVs 360 may include periodic samples of the generated IVs.

In this example, the data store 345 also includes the smoothing parameter 145. For example, the user interface 135 may apply the IIR filter 140 using the smoothing parameter 145 from the data store 345 to generate the CGVM 133. In some embodiments, the smoothing parameter 145 may be selected by a user. In some embodiments, the smoothing parameter 145 may be automatically determined using the historical IVs 360 against a set of user preferences.

FIG. 4 is a flowchart illustrating an exemplary global implied volatility assessment generation method 400. For example, the GIVAS 200 may use the method 400 to generate the CGVM 133. In this example, the method begins when market data (e.g., option data) is retrieved from more than one digital crypto exchanges in step 405. Next, a global order book is generated using the retrieved market data in a subroutine 410. For example, the MDSM 105 may generate the GOB 125 using the received market data. Further details of the subroutine 410 are described with reference to FIG. 5. In step 415, raw IV data is generated. For example, the raw IV data may be generated as described with reference to FIG. 1.

In a decision 420, it is determined whether filter parameters are to be adjusted. For example, the filter parameters may be the smoothing parameter 145 that is used to reduce noise in the raw IV data. If it is determined that the filter parameter is to be updated, in step 425, the filter parameter is updated, and the step 405 is repeated. If the filter parameter is not to be updated, a filter process is applied to the generated raw IV data to generate a CGVM in a subroutine 430. Further details of the subroutine 430 are described with reference to FIG. 6. Next, the CGVM is transmitted to public market exchanges in a step 435. For example, the EPE 205 may transmit the updated IVs to the crypto market exchanges 225. Next, the CGVM is transmitted to user devices in step 440 and the method 400 ends. For example, the FEAWS 250 may use the CGVM 133 to generate a user interface to be display at the computing device 150.

FIG. 5 is a flowchart illustrating an exemplary global order book generation method 500. For example, the method 500 may be the subroutine 410. The method 500 begins when option contracts data from a market exchange is received in step 505. In step 510, the options with an expiry on which a corresponding future contract is also trading are selected. Next, near and next term options are identified in step 515.

After the near term and next term are identified, in step 520, invalid quotes in both near term and next term options are eliminated. In a decision point 525, it is determined whether there are more market exchange data to be processed. If there is more market exchange's data to be processed, then the step 505 is repeated. If all the market exchange's data are processed, in step 530, all data from the market exchanges into one data set. For example, the MDSM 105 may generate the GOB 125 using data from various external sources.

In step 535, a representative data set is selected, based on a first set of predetermined criterion, among a same type of option contracts. For example, the MDSM 105 may select only the OTM option contracts. In step 540, the global order book is generated by selecting options contracts from the representative data set based on a second set of predetermined criterion. For example, the MDSM 105 may select, among option contracts of same expiry and strike, an option contract with a maximum number of bids and a minimum of asks available.

FIG. 6 is a flowchart illustrating an exemplary continuous global volatility metric method 600. The method 600 begins when a raw IV signal and one or more predetermined filter parameters are received in a step 605. For example, the exemplary continuous global volatility metric method 600 may correspond to the subroutine 430 in the method 400.

In a step 610, a filter is applied to the raw IV based on the predetermined filter parameters (e.g., a smoothing parameter(s) 145). In the depicted example, the filter is an “IIR” (infinite impulse response) filter (e.g., IIR filter 140) to generate a filtered IV. For example, the IIR filter may progressively weight samples with lower weights over time without abrupt changes into and out of a filter time window. Accordingly, such embodiments may advantageously reduce noise while ‘smoothing’ abrupt changes in the filtered IV.

The filtered IV signal is then used to generate a CGVM (e.g., by the VMGM 130) in a step 615. For example, the filtered IV signal may be used to generate a ‘user-facing’ metric (e.g., correlated to price and/or return). For example, a square root of the filtered IV signal may be taken to generate the CGVM and/or a multiplier be applied to scale the filtered IV signal. The resulting CGVM may, for example, be used to generate a user interface(s) (UI(s)) showing the CGVM. The UI may, for example, be responsive to time input(s) (e.g., max/min time), to market selection(s), to currency selection(s) (e.g., cryptocurrency), or some combination thereof.

FIG. 7 depicts exemplary user interfaces displaying exemplary market data including an exemplary cryptocurrency global volatility metric for Ethereum and Bitcoin, respectively. A first user interface 700 depicts a transient-dampened CGVM over time for Ethereum. As shown, the first user interface 700 display, for example, historical movements of a volatility (e.g., as represented by the CGVM 133) of Ethereum for a user selected period of time (e.g., 5 years, 1 year, 3 months, 5 days, 1 day).

A second user interface 701 depicts a transient dampened CGVM over time for Bitcoin. Similarly, for example, the second user interface 701 may display a historical representation of a volatility index for Bitcoin. In some examples, a user may insert software code (e.g., the customizable external code 155) to manipulate and/or use the volatility index to generate other useful customized indicators characterizing Bitcoin in a user-selected period of time.

FIG. 8 depicts illustrative experimental data of raw IV values and corresponding filtered IV values (e.g., the CGVM 133) for Bitcoin and Ethereum. In the depicted example, the plot 800 depicts a raw IV signal in grey line (e.g., a volatility metric without filtering), and a corresponding IIR-filtered CGVM in dark line for Bitcoin. The plot 801 depicts a raw IV signal in grey line (e.g., a volatility metric without filtering), and a corresponding IIR-filtered CGVM in dark line for Ethereum. As shown, the raw IV of both assets, Ethereum and Bitcoin, may include various dips 805, 810 and rapid fluctuations 815, 820. These artifacts (805, 810, 815, 820) may generate, for example, discontinuity in generation option contract prices. As shown in the plot 800 and the plot 801, the GIVAS 100 may advantageously smooth these discontinuity artifacts and generate a transient-dampened volatility index. For example, option contract values may be generated without the discontinuity using the transient-dampened volatility index as shown in the plot 800 and the plot 801.

Although various embodiments have been described with reference to the figures, other embodiments are possible.

In various embodiments, the MDSE 330, the VMGE 335, and/or the EPE 340 may cause a general-purpose computer to be transformed into a volatility metric characterization apparatus (VMCE). For example, the VMCE may be operable to determine a global volatility metric of an unstable time-series object (e.g., a cryptocurrency, a cryptocurrency option contract). For example, the VMCE may determine a global volatility metric from (a) an instantaneous data structure that are updated in real-time from N predetermined data sources (e.g., as recorded in the time series database 350), (b) a global order book (e.g., the global order book 355), and (c) a predetermined set of infinite impulse response (IIR) filter parameters (e.g., the smoothing parameter 145). For example, the VMCE may enable computers (e.g., the computing device 150, the VMGM 130, the GIVAS 100) to automatically generate a global volatility metric characterizing a volatility of a temporally updated unstable time-series with removed discontinuity artifacts” using a method that would be highly impractical, if not practically impossible, to simulate by human means, and is not apparently currently practiced in any way. Particularly our claims are directed to producing this global volatility metric characterization by “the use of rules, rather than” humans.

Although an exemplary system has been described with reference to FIGS. 1-2, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a 9V (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IOT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative aspect, a system includes a data store (345) having a program of instructions; a communication interface (310) configured to communicate based on the program of instructions with multiple tracking devices (122a, 122b, 122c) of market data sources (315); a web sockets module (250) configured to provide access to the system from authenticated user devices (150); and, a processor (305) operably coupled to the data store such that, when the processor executes the program of instructions, the processor causes operations to be performed to automatically generate a global volatility metric characterizing a volatility of a temporally updated unstable time-series with removed discontinuity artifacts across the multiple tracking devices, the operations including: receive, through the communication interface, an update of an instantaneous data structure of an unstable time-series object (350) prone to outlying events causing discontinuity in at least one value in the unstable time-series object, wherein the instantaneous data structure may, for example, be received from a predetermined N data sources (210), wherein the predetermined N data sources include independent exchange platforms (115); generate, for each of the predetermined N data sources, an updated time-series representation of the updated instantaneous data structure; aggregate the each of a 1^{st}, 2^{nd}, . . . , N^{th} updated time-series representation of the updated instantaneous data structure into a global order book (355) comprising an instantaneous representation of the unstable time-series object among the predetermined N data sources; generate a raw volatility characterization as a function of the global order book; retrieve, from a first data store, a predetermined set of infinite impulse response (IIR) filter parameters; generate a transient-dampened volatility characterization by applying an IIR filter (140) to the raw volatility characterization the unstable time-series object using the IIR filter parameters (145), such that finite window discontinuity artifacts resulting from the outlying events may be removed; generate a global volatility metric (133) of the unstable time-series object using the transient-dampened volatility characterization; and, transmit, using the web sockets module, the global volatility metric to a user device (150), such that the global volatility metric is usable by an external software code (155).

For example, the system, may, for example, include the unstable time-series object including a plurality of raw option contracts, and generating the updated time-series representation of the updated instantaneous data structure includes selecting a plurality of representative option contracts including: (a) select, from the plurality of raw option contracts, an active set of option contracts, such that each option contracts in the active set of option contracts includes an expiry date on which at least one of the plurality of raw option contracts in future may also being traded; (b) identify, from the active set of option contracts, a plurality of near term option contracts including option contracts expiring within an index maturity date, and a plurality of next term option contracts comprising option contracts expiring out of the index maturity date; and, (c) generate the plurality of representative option contracts by eliminating invalid quotes from the plurality of near term option contracts and the plurality of next term option contracts as a function of bid and ask prices.

For example, the system, wherein the operations further include: amongst the plurality of representative option contracts, identify a highest and lowest strike and option prices; generate an expanded set of valid strike and option prices using a log-linear piece-wise extrapolation, such that the expanded set of valid strike and option prices include strike and options prices from the plurality of representative option contracts and strike and option prices generated by the extrapolation; generating the updated time-series representation using the expanded set of valid strike and option prices.

For example, the system wherein the raw volatility characterization of the updated instantaneous data structure may, for example, be continuously generated, wherein the global volatility metric may, for example, be transmitted to the user device at an interval of less than or equal to 1.5 second.

For example, the system wherein the operations may further include generating a graphical representation of the global volatility metric on the user device, wherein generating the graphical representation includes retrieve, from a second data store, a historical time series of the global volatility metric comprising historical movement of the global volatility metric.

For example, the system, wherein the predetermined N data sources may, for example, include the user device.

For example, the system, wherein transmit the global volatility metric to a user device may include transmitting a data structure of the global volatility metric to a distributed blockchain virtual machine.

In in an illustrative aspect, a computer-implemented method performed by at least one processor (305) to automatically generate a global volatility metric characterizing a volatility of a temporally updated unstable time-series with removed discontinuity artifacts across multiple tracking devices, the method including: receive an update of an instantaneous data structure of an unstable time-series object prone to outlying events causing discontinuity in at least one value in the unstable time-series object (405), wherein the instantaneous data structure may, for example, be received from a predetermined N data sources, wherein the predetermined N data sources include independent exchange platforms; generate, for each of the predetermined N data sources, an updated time-series representation of the updated instantaneous data structure (530); aggregate the each of a 1^{st}, 2^{nd}, . . . , N^{th} updated time-series representation of the updated instantaneous data structure into a global order book comprising an instantaneous representation of the unstable time-series object among the predetermined N data sources (410); generate a raw volatility characterization as a function of the global order book (415); retrieve, from a first data store, a predetermined set of infinite impulse response (IIR) filter parameters (605); generate a transient-dampened volatility characterization by applying an IIR filter to the raw volatility characterization the unstable time-series object using the IIR filter parameters, such that finite window discontinuity artifacts resulting from the outlying events may be removed (430); generate a global volatility metric of the unstable time-series object using the transient-dampened volatility characterization (615); transmit the global volatility metric to a user device, such that the global volatility metric may be usable by an external software code (440); and, generate a graphical representation of the global volatility metric on the user device, wherein the graphical representation includes historical movement of the global volatility metric (135).

For example, the computer-implemented, wherein the unstable time-series object may, for example, include a plurality of raw option contracts, and generating the updated time-series representation of the updated instantaneous data structure includes selecting a plurality of representative option contracts including: (a) select, from the plurality of raw option contracts, an active set of option contracts, such that each option contracts in the active set of option contracts includes an expiry date on which at least one of the plurality of raw option contracts in future may also being traded; (b) identify, from the active set of option contracts, a plurality of near term option contracts comprising option contracts expiring within an index maturity date, and a plurality of next term option contracts comprising option contracts expiring out of the index maturity date; and, (c) generate the plurality of representative option contracts by eliminating invalid quotes from the plurality of near term option contracts and the plurality of next term option contracts as a function of bid and ask prices.

For example, the computer-implemented method, further includes: amongst the plurality of representative option contracts, identify a highest and lowest strike and option prices; generate an expanded set of valid strike and option prices using a log-linear piece-wise extrapolation, such that the expanded set of valid strike and option prices include strike and options prices from the plurality of representative option contracts and strike and option prices generated by the extrapolation; generating the updated time-series representation using the expanded set of valid strike and option prices.

For example, the computer-implemented method, wherein the raw volatility characterization of the updated instantaneous data structure may be continuously generated, wherein the global volatility metric may be transmitted to the user device at an interval of less than or equal to 1.5 second.

For example, the computer-implemented method, wherein the predetermined N data sources includes the user device.

For example, the computer-implemented method, wherein transmit the global volatility metric to the user device may, for example, include transmitting a data structure of the global volatility metric to a distributed blockchain virtual machine.

In an illustrative aspect, a computer program product may, for example, include: a program of instructions tangibly embodied on a computer readable medium wherein when the instructions may be executed on a processor, the processor causes operations to be performed to automatically generate a global volatility metric characterizing a volatility of a temporally updated unstable time-series with removed discontinuity artifacts across multiple tracking devices, the operations including: receive an update of an instantaneous data structure of an unstable time-series object prone to outlying events causing discontinuity in at least one value in the time-series object (405), wherein the instantaneous data structure may be received from a predetermined N data sources, wherein the predetermined N data sources include independent exchange platforms; generate, for each of the predetermined N data sources, an updated time-series representation of the updated instantaneous data structure (530); aggregate the each of a 1^{st}, 2^{nd}, . . . , N^{th} updated time-series representation of the updated instantaneous data structure into a global order book comprising an instantaneous representation of the unstable time-series object among the predetermined N data sources (410); generate a raw volatility characterization as a function of the global order book (415); retrieve, from a first data store, a predetermined set of infinite impulse response (IIR) filter parameters (605); generate a transient-dampened volatility characterization by applying an IIR filter to the raw volatility characterization the unstable time-series object using the IIR filter parameters, such that finite window discontinuity artifacts resulting from the outlying events may be removed (430); generate a global volatility metric of the unstable time-series object using the transient-dampened volatility characterization (615); and, transmit the global volatility metric to a user device, such that the global volatility metric may be usable by an external software code (440).

For example, the computer program product, wherein the unstable time-series object includes a plurality of raw option contracts, and generating the updated time-series representation of the updated instantaneous data structure includes selecting a plurality of representative option contracts including: (a) select, from the plurality of raw option contracts, an active set of option contracts, such that each option contracts in the active set of option contracts includes an expiry date on which at least one of the plurality of raw option contracts in future may also be traded; (b) identify, from the active set of option contracts, a plurality of near term option contracts comprising option contracts expiring within an index maturity date, and a plurality of next term option contracts including option contracts expiring out of the index maturity date; and, (c) generate the plurality of representative option contracts by eliminating invalid quotes from the plurality of near term option contracts and the plurality of next term option contracts as a function of bid and ask prices.

For example, the computer program product, wherein the operations further includes: amongst the plurality of representative option contracts, identify a highest and lowest strike and option prices; generate an expanded set of valid strike and option prices using a log-linear piece-wise extrapolation, such that the expanded set of valid strike and option prices include strike and options prices from the plurality of representative option contracts and strike and option prices generated by the extrapolation; generating the updated time-series representation using the expanded set of valid strike and option prices.

For example. the computer program product, wherein the raw volatility characterization of the updated instantaneous data structure may be continuously generated, wherein the global volatility metric may be transmitted to the user device at an interval of less than or equal to 1.5 second.

For example, the computer program product, wherein the operations further includes generating a graphical representation of the global volatility metric on the user device, wherein the graphical representation includes historical movement of the global volatility metric.

For example, the computer program product, wherein predetermined N data sources include the user device.

For example, the computer program product, wherein transmit the global volatility metric to a user device includes transmitting a data structure of the global volatility metric to a distributed blockchain virtual machine.

Various embodiments may be configured to generate an aggregate implied volatility index for various markets (e.g., cryptocurrency markets). For example, a Market-wide Implied Volatility (MVIV) may advantageously provide comprehensive measurements to assess risk and market sentiment for a dynamic market (e.g., the crypto asset market). For example, the MVIV may generate the measurements using an implied volatility (IV). For example, the IV may include a representation of a fear gauge of investors. For example, the IV may measure volatility extracted from (and/or implied by) options by matching the price of these contracts.

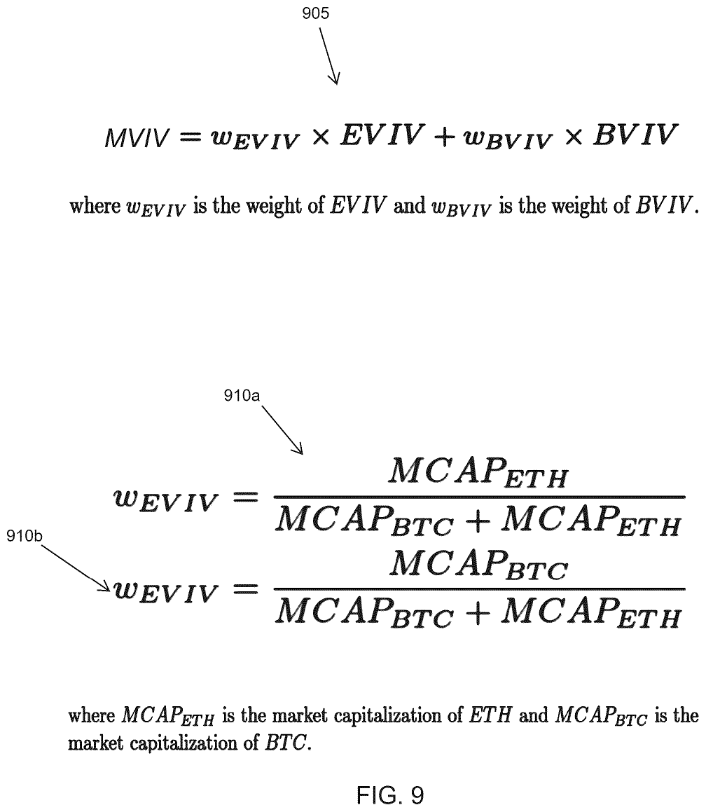

FIG. 9 shows exemplary steps in generating a market wide implied volatility index (MVIV). For example, the MVIV may be generated by applying individual implied volatilities with weights based on underlying asset market capitalizations.

In some implementations, the MVIV may include inputs including implied volatilities (of multiple underlying assets) and weights. For example, the weights may be related to market capitalizations of the underlying assets of the implied volatilities.

In some implementations, MVIV may be a value-weighted average of tradable crypto implied volatilities. The weights, for example, may be the market caps of the underlying assets. As shown in FIG. 9, given BTC and ETH implied volatility indices, BVIV and EVIV, MVIV can be written as an equation 905. For example, the weight of EVIV and the weight of BVIV may be calculated using equations 910a, 910b, respectively.

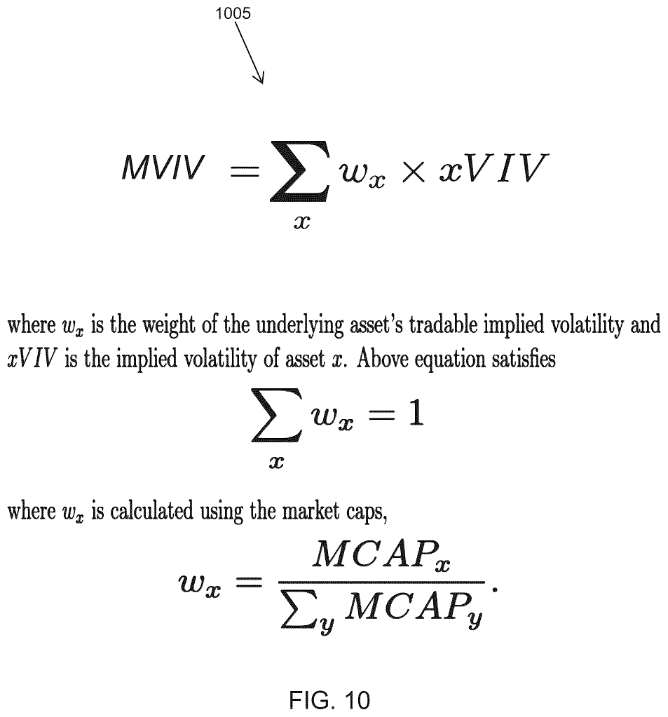

As shown in FIG. 10, a generalized MVIV may be calculated using an equation 1005 when considering multiple tradable implied volatilities. Various embodiments may capture an aggregate total implied volatility of the crypto assets. Accordingly, the MVIV may advantageously provide a current uncertainty in the market as a single number. Appendix A introduces a new aggregate implied volatility index for cryptocurrency markets.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A system comprising:
a data store (345) comprising a program of instructions;
a communication interface (310) configured to communicate based on the program of instructions with multiple tracking devices (122a, 122b, 122c) of market data sources (315);
a web sockets module (250) configured to provide access to the system from authenticated user devices (150); and,
a processor (305) operably coupled to the data store such that, when the processor executes the program of instructions, the processor causes operations to be performed to automatically generate a global volatility metric characterizing a volatility of a temporally updated unstable time-series with removed discontinuity artifacts across the multiple tracking devices, the operations comprising:
receive, through the communication interface, an update of an instantaneous data structure of an unstable time-series object (350) prone to outlying events causing discontinuity in at least one value in the unstable time-series object, wherein the instantaneous data structure are received from a predetermined N data sources (210), wherein the predetermined N data sources comprise independent exchange platforms (115);
generate, for each of the predetermined N data sources, an updated time-series representation of the updated instantaneous data structure;
aggregate the each of a 1^{st}, 2^{nd}, . . . , N^{th} updated time-series representation of the updated instantaneous data structure into a global order book (355) comprising an instantaneous representation of the unstable time-series object among the predetermined N data sources;
generate a raw volatility characterization as a function of the global order book;
retrieve, from a first data store, a predetermined set of infinite impulse response (IIR) filter parameters;
generate a transient-dampened volatility characterization by applying an IIR filter (140) to the raw volatility characterization the unstable time-series object using the IIR filter parameters (145), such that finite window discontinuity artifacts resulting from the outlying events are removed;
generate measurements, via a market-wide implied volatility, using an implied volatility;
generate a global volatility metric (133) of the unstable time-series object using the transient-dampened volatility characterization; and,
transmit, using the web sockets module, the global volatility metric to a user device (150), such that the global volatility metric is usable by an external software code (155).
